(19) United States
(12) Patent Application Publication
(10) Pub. No.: US 2012/0308301 A1
(43) Pub. Date: Dec. 6, 2012

(54) APPARATUS AND METHOD FOR DETACHABLY FASTENING A GRIPPER

(76) Inventors: Julia Walsch, Erndtebruck (DE); Thorsten Schleicher, Bad Laasphe (DE)

(21) Appl. No.: 13/483,773

(22) Filed: May 30, 2012

(30) Foreign Application Priority Data
Jun. 1, 2011 (DE) 10 2011 103 097.6

(51) Int. Cl. F16D 1/00; B23P 11/00

(52) U.S. Cl. 403/361; 29/428

(57) ABSTRACT

The present disclosure relates to an apparatus and a method for detachably fastening a gripper to a robot, especially a delta robot, comprising a receiving unit and a coupling unit between which at least one form-fit and/or one force-fit connecting element is provided. The receiving unit includes a limit stop provided with an undercut to receive a first section of the coupling unit therein. Furthermore, the receiving unit and the coupling unit include complementary form elements designed to be inserted into each other. Finally, the receiving unit includes a clamping element for retaining the coupling unit in abutment with the receiving unit. The invention disclosure further relates to a method for detachably fastening a gripper to a robot.

The present invention relates to an apparatus and a method for detachably fastening a gripper to a robot, especially a delta robot. The apparatus includes a receiving or holding unit and a coupling unit between which at least one form-fit and/or one force-fit connecting element is provided.

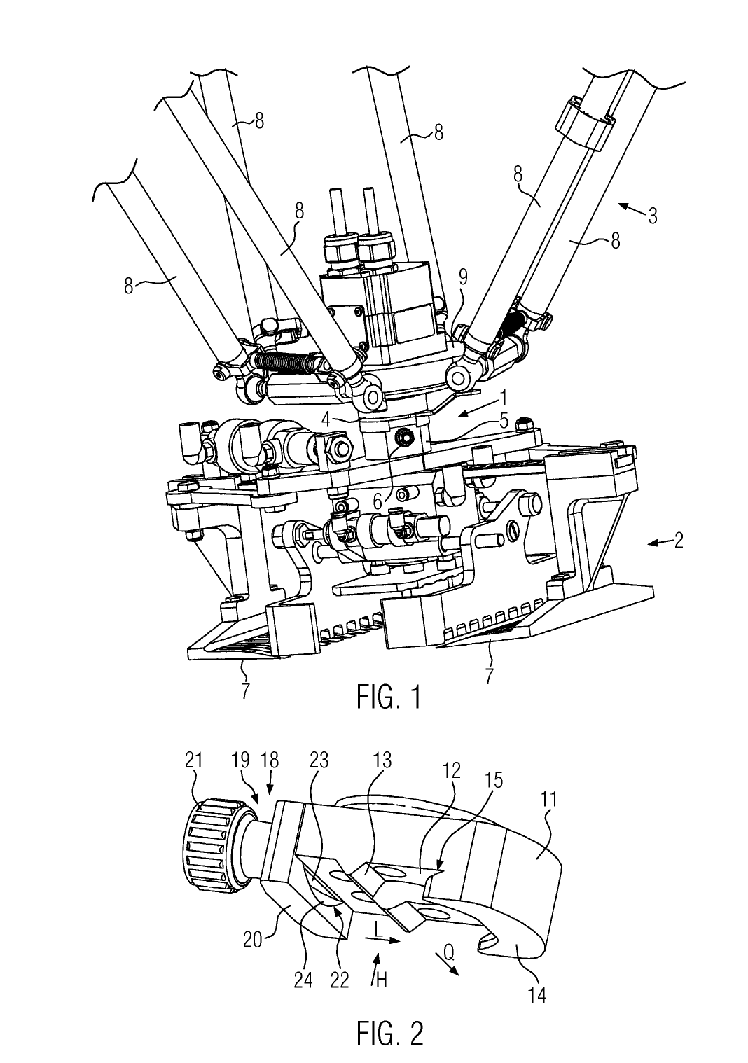

Such apparatuses are known in the prior art. FIG. 1, for instance, shows a fastening device 1 arranged between a gripper 2 and a delta robot 3. In order to equip the delta robot 3 with a plurality of various grippers 2, a projecting part of a receiving unit 4 fixed to the delta robot 3 is inserted into a coupling unit 5 of gripper 2. The receiving unit 4 and the coupling unit 5 are fastened to each other by means of a screw 6. It is disadvantageous in such a system that driving in the screw is relatively elaborate and an adequate tool is required for tightening the screw with the requisite force.

Basing on the prior art as known, it is the object of the present invention to provide an apparatus and a method for detachably fastening a gripper so as to make gripper replacements easier and faster.

Such an apparatus can be obtained in that the receiving unit comprises a limit or end stop provided with an undercut for receiving a first section of said coupling unit therein, that the receiving unit and the coupling unit further include complementary form elements designed to be inserted one into the other, and in that the receiving unit further includes a clamping element for retaining the coupling unit in the limit stop of the receiving unit.

Owing to said undercut, the first section of the coupling unit is retained by positive locking. The clamping element is, thus, relieved and has only to make sure that the coupling unit will remain in the limit stop of the receiving unit. Furthermore, the process of insertion has become easier, as inserting the coupling element into the limit stop can be done easily and the position between receiving unit and coupling unit substantially has already been determined. Then, the clamping element is operated in such a manner that the coupling unit is entirely locked in said limit stop. To prevent that the coupling unit is inserted into the receiving unit with an undesired orientation, complementary form elements are being provided interlocking with each other merely in the orientation as scheduled, thus enabling the coupling unit to be inserted into the receiving unit. In case of misorientation of said coupling unit with regard to the receiving unit, the complementary form elements are prevented from interlocking with each other so that it is not possible to insert the coupling unit into the receiving unit. This can be found out easily, and each user can reorient the coupling unit.

In other embodiments, the complementary form elements may also be omitted, yet achieving the object of the invention.

The complementary form elements are particularly designed in a manner enabling the coupling unit to be inserted into the receiving unit in just one orientation.

Advantageously, the receiving unit is provided at the robot, and the coupling unit is provided at the gripper. Usually, such receiving unit is a complex component which, in many grippers, has to be provided for the robot just once, while the coupling unit of relatively simple design is provided for each gripper. For other applications, in which grippers of e.g. a more complex design with a plurality of diverse simple robots are used, it may also be possible to provide the gripper with the receiving unit and the robot with the coupling unit of more simple design.

In one embodiment, the form element of the receiving unit is a bump, and the form element of the coupling unit is a complementary indentation. Accordingly, the surface of the coupling unit can be designed without any projecting regions so that the grippers may be designed in a more compact form. Moreover, the coupling unit can be manufactured more easily and, thus, at a reasonable price.

In other embodiments, however, it may also be possible that the form element of the coupling unit is a bump, and the form element of the receiving unit is a complementary indentation.

Advantageously, the bump and the indentation are at least partially conically shaped so that even in case of inaccurate orientation insertion of the bump into the indentation is guided and, thus, facilitated.

For reasons of simplification, the normal of the base areas of the receiving unit and of the coupling unit can be defined as height direction; it is, yet, pointed out that, owing to the movable character of a robot, said direction between both gripper replacement and the moment of gripper replacement is by no means just vertically upwards. The longitudinal direction which is orthogonal to the height direction is defined as being the direction indicating the direction into which the coupling unit extends into the undercut of the limit stop of the receiving unit. A transverse direction is defined orthogonally with regard to both the height and the longitudinal direction.

The direction of extension of the groove is substantially the transverse direction. The groove is primarily recessed in longitudinal direction.

In particular, the groove may be formed continuously, with especially the radius of curvature of this form being constant, i.e. it forms the circumference of a circular segment.

Owing to the fact that the groove does not only extend straightly in transverse direction with the same depth, it is possible that the groove also provides positive locking in transverse direction so that the coupling unit cannot be shifted in the receiving unit in transverse direction. Nevertheless, the coupling unit can be inserted in a relatively simple manner, as the coupling unit may, first of all, also be inserted into the limit stop even when in slightly misoriented condition. It may then there be oriented correctly until the first section has been received in the undercut of the limit stop in a way as intended.

As an alternative to the design of the indentation as a groove, said indentation may also be in the form of a recess or a bore into which a corresponding projection of the coupling unit can be inserted.

The receiving unit may also be provided with a projection as limit stop which can be inserted into an indentation of the coupling unit.

Advantageously, the limit stop is designed as a groove with conically extending side faces, the first section of the coupling unit being of complementary conical shape, in order to ensure that the first section of the coupling unit fits into the limit stop of the receiving unit with no play. The conical shape of a first section particularly is a longitudinally tapering shape, wherein the conically extending side faces of said groove make same narrower in the longitudinal direction. While inserting the first section of the coupling unit into the limit stop of the receiving unit, the corresponding conical faces inclined at the same angle come into contact with each other, thus determining the position of the first section of the coupling unit in the limit stop of the receiving unit with no play. Moreover, the conical side faces have the advantage that the process of inserting the coupling unit into the limit stop of the receiving unit has been facilitated.

In particular, the clamping element and the limit stop are provided at the receiving unit in a manner spaced apart from each other so that the coupling unit can be inserted therebetween. Further, the clamping element and the limit stop are primarily provided on opposing sides with regard to the coupling unit. Accordingly, a force-fit or form-fit connection may be applied from the receiving unit to the coupling unit from both sides which has, thus, been locked advantageously. It is, of course, also possible to provide a plurality of clamping elements and/or a plurality of limit stops provided with an undercut in said receiving unit, which will then primarily be distributed along the circumference of the receiving unit.

Advantageously, said clamping element and said limit stop are arranged on two opposite sides of a base plate of said receiving unit, and the complementary form elements are arranged between said clamping element and said limit stop. Thus, the complementary form elements are arranged in the region of extent of said coupling unit and can ensure, without providing any further adjacent areas, that the coupling unit can only be inserted into the receiving unit when correctly oriented.

According to one embodiment, the clamping element includes a limit stop with an undercut designed to receive a second section of the coupling unit, said second section being arranged opposite to the first section of the coupling unit. While the limit stop of the receiving unit is primarily stationary to receive the first section of the coupling unit therein, the limit stop of the clamping element is provided in a movable component, especially a clamping plate. As soon as the first section of the coupling unit has been inserted into the undercut of the limit stop of the receiving unit, the clamping unit can be moved towards the coupling unit such that the second section of the coupling unit comes into engagement with the limit stop of the clamping element and is held by the undercut thereof. In particular, the first and the second section are provided on opposite sides of the coupling unit.

Advantageously, the limit stop of the clamping element is a groove recessed in its center region of extension with conical side faces, the second section of said coupling unit also being conically shaped. The region of extension of the groove of said clamping element primarily is also substantially the transverse direction. Recessing the groove has the effect that locking in the transverse direction becomes possible. The conical side faces ensure that the second section of the coupling unit fits into the groove with no play. The features of the groove recessed in its center region of extension and of the conical side faces may also be provided separately, without being required to provide the other feature, respectively.

Advantageously, the clamping element comprises a clamping plate in which the limit stop is formed, and a screw for locking and/or pre-clamping the clamping plate towards the coupling unit. Mere locking can be obtained by positive locking when the screw urges the clamping plate against a limit stop provided at the receiving unit, without applying a force to the coupling unit in this direction. It is, however, preferred to tighten the screw such that the clamping plate applies a pre-clamp force to the coupling unit. The screw primarily extends in longitudinal direction so that it can press the coupling unit into the limit stop provided with an undercut of the receiving unit.

Advantageously, the screw has a grip. As the screw merely has to lock the clamping plate in the suitable position, only a minor fastening force is required than in case of the prior art fastening apparatus. Accordingly, the hand force applied to the grip suffices to fasten the coupling unit to the receiving unit. Thus, the mounting process was substantially made easier and faster.

In some embodiments, the clamping plate may also be flat so that it merely applies a force in longitudinal direction to the coupling unit, while there is no positive locking in height direction but primarily a frictional connection due to the frictional force in height direction. However, due to the fact that the first section of the coupling unit engages behind the limit stop of the receiving unit, there is also a positive locking. In case the coupling unit moves substantially with regard to the clamping plate, there is another positive locking owing to the design of the clamping plate so that the coupling unit cannot fall out.

Advantageously, the limit stop is formed by an indentation in one side wall of the receiving unit so as to form the undercut. Principally, both the receiving unit and the coupling unit include a base area lying, when the gripper is fastened, against each other or being arranged in close proximity to each other. The side wall is primarily substantially arranged to the base area at a right angle. The side wall can generally only be formed by means of a shoulder or landing in the receiving unit. In said side wall, the corresponding indentation will then be formed so that the first section of the coupling unit can be received or accommodated therein, thus engaging behind the material of said side wall in such a manner that an undercut is formed.

Advantageously, the indentation of the limit stop is in the form of a groove extending in the direction of extension of the side wall, the groove being recessed in its center region in the direction of extension so that the coupling unit can safely be locked in the direction of extension of said groove.

In one embodiment, the limit stop is formed in a counter clamping element designed to move, relative to a center element of the receiving unit, into a direction opposite to the movement of the clamping element, in order to fasten the coupling unit between the clamping element and the counter clamping element. Due to the concurrent adjustment of clamping element and counter clamping element, the coupling unit can be fastened in the receiving unit with a slight shift or displacement of each of said clamping elements. In particular, said counter clamping element and said clamping element move at the same speed and over the same distance. Furthermore, said arrangement has the advantage that the coupling unit can substantially be inserted centrally into the receiving unit and remains substantially in the same position during the fastening process and the opening process of said clamping elements.

Advantageously, the screw passes through the receiving element, the screw for the clamping element and for the counter clamping element comprising regions with reversed pitch, respectively, with which said clamping element and said counter clamping element are in engagement, respectively. Thus, turning the screw in one direction causes an opposite movement of said clamping element and said counter clamping element. The fastening process and the opening process of the clamping elements with regard to the coupling unit had, thus, been facilitated.

Advantageously, the limit stop of the counter clamping element and the limit stop of the clamping element are in the form of straight grooves parallel to each other, and, depending on the turning position, the screw engages into an indentation of the coupling unit in order to lock the coupling unit with regard to the receiving unit in the direction of extension of the grooves. Due to their straight form parallel to each other, such locking is not possible with said grooves. In particular, the indentation of the coupling unit is provided on a bump on said coupling unit. Said bump on said coupling unit may particularly be the complementary form element of said coupling unit which is inserted into a corresponding complementary form element of the receiving unit, e.g. a groove, thus particularly ensuring that the coupling unit can be inserted into the receiving unit in just one orientation.

In yet another embodiment, the clamping element is designed in such a manner that the coupling unit is held by means of a magnetic force. Again, the coupling unit is primarily held by the limit stop provided with the undercut. To avoid that the coupling unit slips out of the limit stop, a magnetic force is applied to the coupling unit which preferably acts in height direction and which prevents that the coupling unit slips out of the undercut of the receiving unit. In addition, the magnetic force also exerts a retaining force in height direction in those regions of the coupling unit spaced-apart from the first section of the coupling unit.

In one embodiment, the receiving unit is provided with a stop wall arranged opposite to the limit stop provided with the undercut. The stop wall of the receiving unit prevents slipping of the coupling unit in transverse direction, while the clamping element prevents turning the coupling unit out in height direction by means of a magnetic force.

Advantageously, the clamping element is operable so that the magnetic force can either be switched on or off.

In one embodiment, the receiving unit is provided with an electromagnet designed to apply the magnetic force to the coupling unit.

In yet another embodiment, the receiving unit is provided with a switchable permanent magnet designed to apply the magnetic force to the coupling unit. In particular, this refers to a turnable permanent magnet which supplies, depending on the turning position, a magnetic force by which the coupling unit is safely held on said receiving unit, or which enables detaching of the coupling unit from said receiving unit. An example for such turnable permanent magnet can be found in the EP 114 259 A1.

Advantageously, the electromagnet or the switchable permanent magnet is arranged in the base plate of the receiving unit or at the side of the base plate facing away from the coupling unit.

The coupling unit includes either a permanent magnet interacting with the electromagnet or the switchable permanent magnet, or is at least partially or entirely made of a ferromagnetic material which allows that a magnetic force between the receiving unit and the coupling unit is generated.

In one embodiment, the receiving unit includes a locking pin engaging into the coupling unit in order to avoid that the first section of the coupling unit is released or detached from the limit stop as soon as the magnetic retaining force is switched off. Such locking pin is just an additional securing element which usually is not in engagement with the coupling unit and only holds or retains the coupling unit when there is no magnetic force. This may either be in case of gripper replacement or in case of poor operating conditions.

In particular, the locking pin is pre-tensioned towards the coupling unit which has an indentation into which said locking pin engages. The coupling unit may have an inclination so that during insertion of the coupling unit into the receiving unit said locking pin is automatically pressed backwards before it snaps into the indentation of the coupling unit. The indentation of the coupling unit is primarily arranged opposite to the first section.

To remove the coupling unit from the receiving unit, the locking pin has to be retracted especially against the action of a spring.

As an alternative to the locking pin, a safety screw may also be used.

The grippers are particularly designed to pick-up and put down products, especially food products. Food products primarily are food slices cut-off from a food loaf. Such slices are, for instance, cold meat or sausage, cheese or ham slices.

The gripper and/or robot comprise a control unit which enables exact movements of said robot and of said movable gripper parts.

The fastening apparatus according to the invention may comprise integrated intersections for the transmittal of data and/or for the power supply so that the gripper can be actuated and driven in a controlled manner. Power can be supplied especially in the form of pressurized air or electricity.

The control unit is advantageously digitally, i.e. a computer control equipped with software.

The robot and the grippers are advantageously controlled in that information on the positions of the products is made available which will be processed by means of said control unit. Such information is either transmitted to said control unit by preceding systems, e.g. a cutting machine, or detected by sensors.

Moreover, information on the size and/or orientation of the products to be picked-up by the grippers can be made available and processed.

For instance, it may be conceivable that a camera system detects the positions and/or the sizes of the products. The camera system may either be provided stationary or be integrated into the robot or gripper.

Primarily, the robot is included in a robot cell which provides a rack for fastening the robot. Furthermore, such robot cell may contain protective walls to make the operations of the robot safer. In particular, the protective walls include an entry to the robot that can either be opened or closed. A sensor provided at the entry can be connected to the control unit and give notice of an either closed or opened state so that the robot will be stopped when in the opened state. Furthermore, the protective walls may at least partially be transparent.

The robot includes at least one drive motor, especially with gears.

Primarily, the robot includes robot arms which may be arranged either parallel and/or sequential. In particular, each of said robot arms includes at least one drive motor primarily driving the robot arm via a gearing.

The robot arm drives are controlled by said control unit.

Moreover, the robot arm particularly includes seats for the drive motor and for the gearings so that same can be fastened.

The robot arm consists of at least one upper arm and one lower arm, the upper arm being connected to the lower arm primarily via a hinge.

Furthermore, a virtual coordinate system is particularly calculated for determining the arrangement of the robot and of the gripper and of the products so as to enable optimal positioning and moving of robot and gripper.

In the following, advantageous embodiments of the invention will be described with regard to the Figures, in which:

FIG. 1 shows the general arrangement of a generic apparatus for fastening a gripper to a delta robot.

FIG. 2 shows a receiving unit of a first embodiment of the fastening apparatus according to the invention.

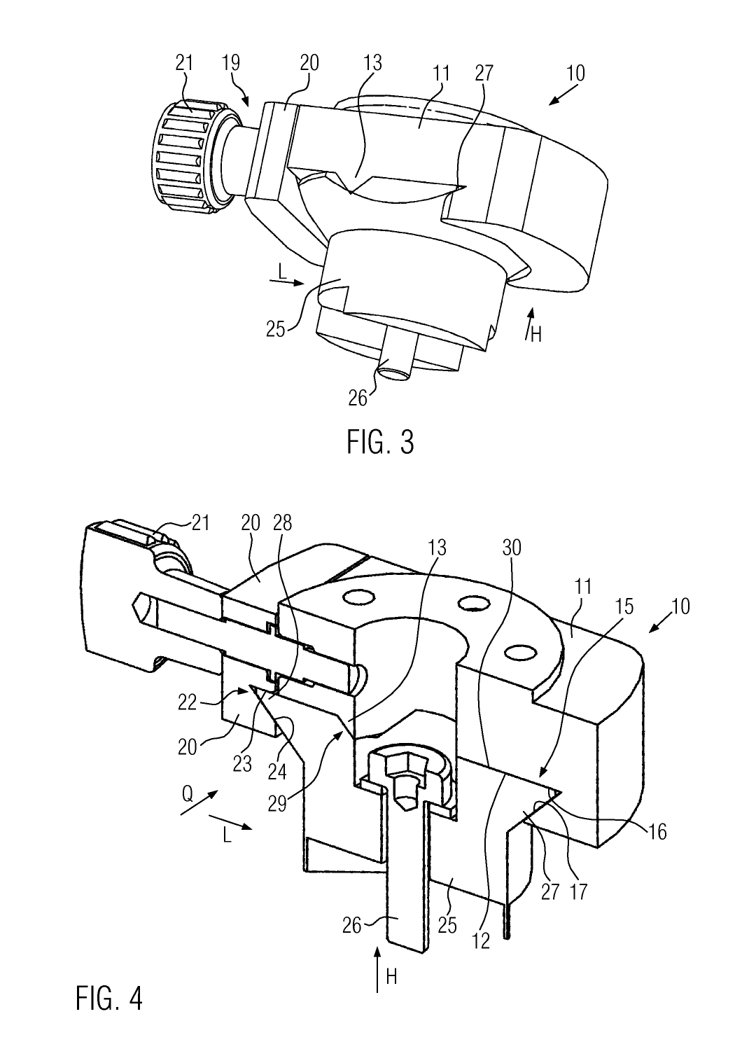

FIG. 3 shows a coupling unit being inserted into the receiving unit of the first embodiment of the fastening apparatus according to the invention.

FIG. 4 shows a perspective sectional view of the first embodiment of the fastening apparatus according to the invention.

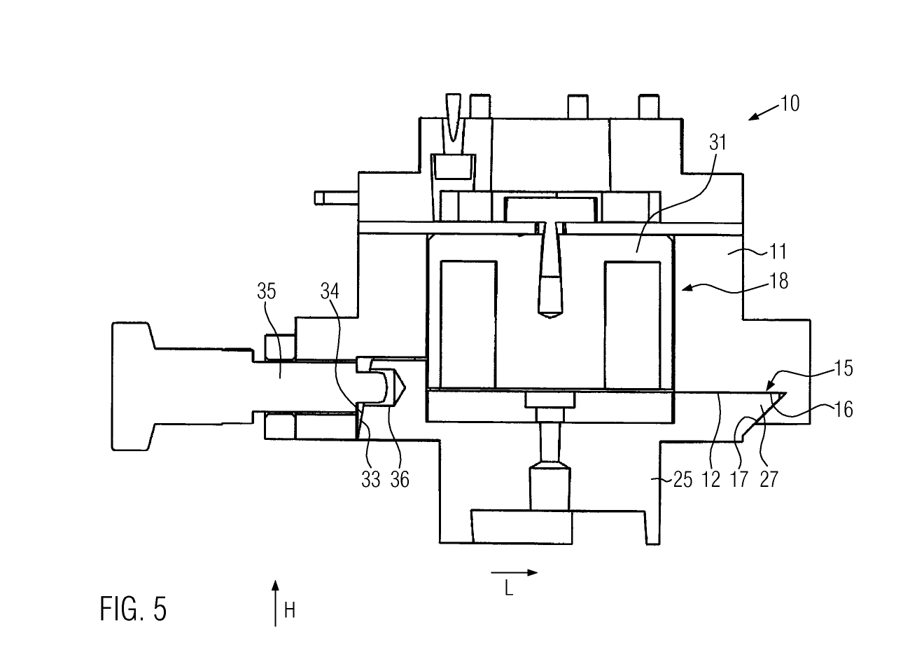

FIG. 5 shows a plane sectional view of another embodiment of the fastening apparatus according to the invention.

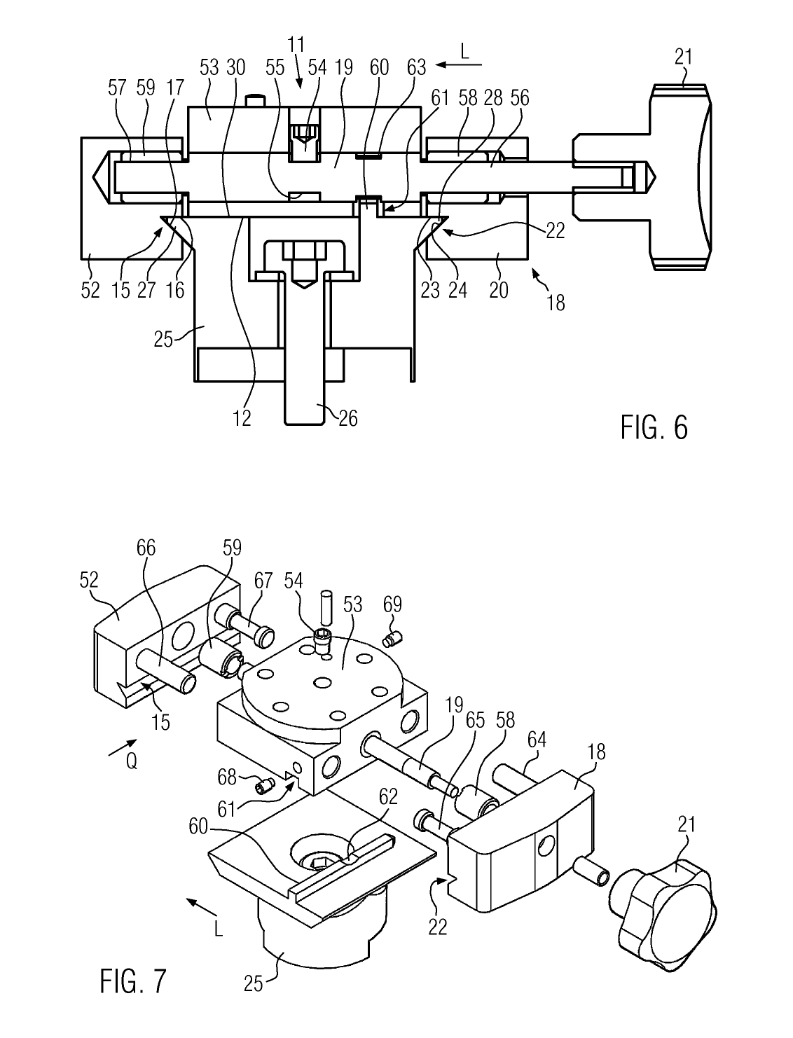

FIG. 6 shows a sectional view of a third embodiment of the fastening apparatus according to the invention.

FIG. 7 shows a perspective exploded view of the third embodiment of the fastening apparatus according to the invention.

Referring to FIG. 1, the arrangement of fastening apparatus 10 according to the invention will be explained again, which is, corresponding to the conventional fastening apparatus 1, arranged between a gripper 2 and a delta robot 3. Gripper 2 comprises two receiving elements 7 that can be used to receive and convey food products or stacks of food products. Examples for such food products are, for instance, sliced sausages or cold meat, cheese or ham. Gripper 2 is fastened to an element 9 movable via robot arms 8 of delta robot 3 by means of fastening apparatus 1. The stationary element of delta robot 3 is not shown in said drawing, since only the end portions of robot arms 8 are shown, respectively.

A first embodiment of a fastening apparatus 1 according to the invention will now be explained with regard to FIGS. 2 to 4. FIG. 2 shows the receiving unit 11 which is fastened to the movable element 9 of delta robot 3. Receiving unit 11 includes a base plate 12 with a bump 13. Bump 13 primarily extends in transverse direction Q and includes tapering side walls. Bump 13 is of either leveled or pointed design. Base plate 12 is restricted on one of its sides by a side wall 14 also basically extending in transverse direction Q, yet being of a slightly rounded form. At its upper end, side wall 14 merges into base plate 12 in height direction H.

A limit stop 15 formed by the side faces 16, 17 (see FIG. 4) of the groove is provided at the intersection between side wall 14 and base plate 12. Side face 16 substantially is a continuation of base plate 12. Alternatively, side face 16 may, however, not be a constant continuation of base plate 12 but a face stepped thereto. Side face 17 is arranged at an acute angle with regard to side face 16 so that side faces 16, 17 are conically or tapered to each other.

A clamping element 18 is provided at the side opposite to base plate 12 in longitudinal direction L. Clamping element 18 includes a screw 19 for locking and/or pre-clamping a clamping plate 20 in longitudinal direction L. Clamping screw 19 particularly includes a grip 21, thus enabling to tighten or loosen it without any assembly tool being required.

Clamping plate 20 is also provided with a limit stop 22 in the form of a groove so that the limit stop 22 also includes an undercut. The groove of limit stop 22 is formed by a side face 23 substantially being arranged at the height of base plate 12. In other embodiments, side face 23 can be stepped in height direction H with regard to base plate 12. Further, limit stop 22 includes a side face 24 arranged at an acute angle with regard to side face 23. Accordingly, side faces 23 and 24 are tapered with regard to each other. When clamping screw 19 is turned by grip 21 around its screw axis, clamping plate 20 is either loosened in longitudinal direction L or pre-tensioned, or shifted in longitudinal direction L.

FIG. 3 shows coupling unit 25 while being inserted into receiving unit 11. A gripper 2 is fastened to coupling unit 25, said gripper not being shown in FIG. 3 for reasons of clarity. Gripper 2 can be fastened particularly by means of screw 26 arranged in a center bore of coupling unit 25.

As can be seen in FIGS. 3 and 4, a first section 27 of coupling unit 25 engages under limit stop 15 of receiving unit 11 so as to be retained therein by means of an undercut. On the opposite side, another section 28 of coupling unit engages under limit stop 22 of clamping plate 20. Thus, second section 28 is also locked and coupling unit 25 as a whole secured against shifting.

FIG. 4 is a perspective sectional view showing the engagement of the first and the second section 27, 28 into limit stops 15, 22. Furthermore, said sectional view also shows bump 13 of receiving unit 11 and the engagement thereof into a corresponding indentation 29 of coupling unit 25. In other embodiments, said indentation may also be provided in receiving unit 11, while bump 13 may be provided in coupling unit 25.

As shown in FIGS. 2 and 3, limit stop 15 is of a recessed form in its center region in transverse direction, i.e. a first section 27 of coupling unit 25 can project deeper in its center region into side face 14 in longitudinal direction L than in the side regions. Thus, coupling unit 25 is fixed in transverse direction with regard to receiving unit 11.

In the following, the process of fastening gripper 2 to robot 3 and the process of loosening gripper 2 from robot 3 are being described.

First, receiving unit 11 is in the state as shown in FIG. 2, with gripper 2 with coupling unit 25 not yet being inserted into receiving unit 11 of robot 3. First, clamping screw 19 is untightened by turning grip 21 so that clamping plate 20 can be retracted in the direction of grip 21 so as to release the side region of base plate 12 assigned to clamping plate 20.

Then, coupling unit 25 is approached to receiving unit 11 from below in height direction. Alternatively, coupling unit 25 may also be stationary together with the gripper, and receiving unit 11 can be lowered onto coupling unit 25.

Receiving unit 11 and coupling unit 25 are positioned with regard to each other in a manner that the first section 27 of coupling unit 25 has at least partially been inserted into limit stop 15, while base plate 30 of coupling unit 25 is at an angle to base plate 12 of receiving unit 11 so that the second section 28 is arranged still underneath clamping plate 20 in height direction H. Then, second section 28 is also being lifted until it reaches the height of limit stop 22. During this movement, the distance between base plates 12 and 30 diminishes, and bump 13 fits or inserts into indentation 29 when receiving unit 11 and coupling unit 25 are correctly oriented with regard to each other. In case coupling unit 25 is misoriented with regard to the receiving unit, e.g. because second section 28 was inserted into limit stop 15, base plates 12, 30 cannot be lowered one upon the other due to bump 13 and indentation 29. This can be obtained in that indentation 29 and bump 13 are arranged in decentralized manner between first section 27 and second section 28 of coupling unit 25.

When base plate 12 and base plate 30 have been arranged one onto the other or maximally approached to one another, clamping screw 19 is fastened by being turned at grip 21 so as to shift clamping plate 20 in a manner that it receives second section 28 of coupling unit 25 in its limit stop 22. As soon as second section 28 lies against the side faces 23, 24 of clamping plate 20, a small gap still exists between clamping plate 20 and the wall of receiving unit 11 opposite thereto. Hence follows that further turning of the clamping screw 19 causes that the pre-tensioning applied by limit stops 15, 22 to first and second section 27, 28 of coupling unit 25 are exactly set.

Releasing or disengaging coupling unit 25 is done in a directly opposed manner. First, clamping screw 19 is released by turning grip 21, and then clamping plate 20 is displaced or shifted so that second section 28 of coupling unit 25 is released. Thereafter, second section 28 is first lowered with regard to the receiving unit until the coupling unit can be moved in longitudinal direction in such a manner that first section 27 can also be removed from limit stop 15.

It is here again stated that in both cases, i.e. either when fastening or when loosening the gripper, either receiving unit 11 with regard to the stationary coupling unit 25, coupling unit 25 with regard to stationary receiving unit 11, or both elements concurrently with regard to each other can be moved.

FIG. 5 shows another embodiment of fastening apparatus 10 according to the invention. Similar parts were given the same reference numbers as in case of the first embodiment, wherein the differences between the embodiments primarily being referred to in the following. Again, fastening apparatus 10 comprises a receiving unit 11 into which a coupling unit 25 can be inserted; to this end, first section 27 of coupling unit 25 can be inserted at one side into limit stop 25 of receiving unit 11 so as to be locked therein via an undercut. The substantial difference between the two embodiments is in the design of clamping element 18. Clamping element 18 includes an electromagnet 31 provided in receiving unit 11 and forming part of base plate 12. Opposite thereto, coupling unit 25 is provided with a permanent magnet which forms part of base plate 12 of coupling unit 25. Said permanent magnet can especially be fastened to coupling unit 25 by means of a screw. Alternatively, the coupling unit may just be provided with an insert of ferromagnetic material or can entirely be made of a ferromagnetic material.

When power is supplied to electromagnet 31 it generates a magnetic field applying an attractive force to the permanent magnet in height direction H, thus preventing that coupling unit 25 detaches from receiving unit 11. However, a substantial amount of force is still adopted in height direction H, owing to the engagement of first section 27 with the undercut of limit stop 15 so that coupling unit 25 is safely fastened in receiving unit 11. At the opposite end of the receiving unit starting from limit stop 15, a side wall 33 is formed that can come into contact with at least one region or an edge of side wall 34 of coupling unit 25. Side wall 33 prevents that coupling unit 25 can move in longitudinal direction L with regard to receiving unit 11 which might cause that first section 27 slips out of limit stop 15.

Side wall 33 of coupling unit 25 is penetrated by a locking pin 35 that may engage into a recess 36 of coupling unit 25. Recess 36 is provided in coupling unit 25 at the opposite side with regard to first section 27. In particular, locking pin 35 is preloaded by a spring force towards recess 36. If, intentionally or unintentionally, the magnetic force of electromagnet 31 is no longer available, locking pin 35 prevents that gripper 2 can fall out of receiving unit 11 along with coupling unit 25. When gripper 2 has to be replaced locking pin 36 merely has to be pulled so that it disengages from recess 36, thus enabling that gripper 2 can be removed in downward direction.

In particular, side wall 34 of coupling unit 25 includes an inclination in height direction enabling that coupling unit 25 can be inserted into receiving unit 11 in tilted position with regard to receiving unit 11. Moreover, such inclination of side wall 34 can be such that it automatically interacts with locking pin 35 so that same will automatically be forced back when coupling unit 25 is being inserted, and no additional maneuver for retracting locking pin 35 will be required.

Electromagnet 31 can be operated automatically when the delta robot starts to work and is, thus, supplied with power. When in the deactivated state, it is usually not necessary to activate electromagnet 31, as locking pin 35 has, at least when in stationary state, enough holding or retaining force for holding or retaining coupling unit 25 in receiving unit 11.

While inserting coupling unit 25 into receiving unit 11, a mounting force has to be provided which serves to hold gripper 2 at the robot arm. Such mounting force may either be caused by the above-described locking pin 35 or by an additional connection via another permanent magnet. Before robot 3 starts to work, the safety door of the robot cell has to be closed. Such closing of the door is taken as a signal to switch electromagnet 31. Then, with the safety door being closed, electromagnet 31 provides the force required to operate the robot for holding gripper 2.

The process of inserting coupling unit 25 into receiving unit 11 corresponds to that one of the first embodiment, with the exception that instead of tightening clamping plate 20, electromagnet 31 is switched on, or locking pin 35 is brought into engagement with recess 36.

It should be noted that the second embodiment can be amended in that no magnet is provided but locking pin 35 exclusively engaging into recess 36 as clamping element. To this end, locking pin 35 has to be suitably designed so that a safe seat with, at best, no play of coupling unit 25 designed in such a manner can be obtained in receiving unit 11.

FIG. 6 is a sectional view of a third embodiment of the invention. Said third embodiment has much in common with the first embodiment, so that same parts were given the same reference numbers and it is referred to the corresponding statements with regard to said first embodiment. In the following, the differences between the third and the first embodiment will primarily be explained.

According to the third embodiment, receiving unit 11 does not only include a clamping element 18 but also a counter clamping element 52 which may also primarily be designed as clamping element. Clamping element 18 and counter clamping element 52 are provided at opposing sides of a central element 53 at receiving unit 11. In particular, clamping element 18 and counter clamping element 52 are arranged at opposing sides of base plate 12 of receiving unit 11. Screw 19 passes entirely through central element 53, wherein screw 19 has primarily been received in a bore through central element 53 so as to be supported therein in a sliding manner. To avoid axial shift of screw 19 in central element 53, a safety screw 54, or any other comparable projecting safety element, is provided extending into a central annular groove 55 which is formed around the entire circumference of screw 19.

At both of its ends outside central element 53, screw 19 is provided with threaded areas 56, 57 being provided with threads of opposite pitches, respectively. Particularly, one of said threaded areas 56, 57 is a left-hand thread and the other of said threaded areas 56, 57 is a right-hand thread. Threaded areas 56, 57 are in engagement with clamping elements 18, 52, respectively. To this end, clamping elements 18, 52 may be provided with thread inserts 58, 59 in order to enhance the stability of the apparatus. If screw 19 is now turned by means of grip 21, clamping elements 18, 52 move in opposite directions along longitudinal direction L, thus releasing first section 27 and second section 28 of the coupling unit or lock same in the respective limit stops 15, 22. Limit stops 15, 22 particularly are formed by parallel grooves extending in transverse direction in clamping elements 18, 52, respectively.

Moreover, a bump 60 is formed on base plate 30 of the coupling unit, which, with coupling unit 25 being in the inserted state, engages into a recess 61 provided in base plate 12 of central element 53 of receiving unit 11. In particular, bump 60 and recess 61 are formed in such a manner that they do not extend over the entire length or width of coupling unit 25 so that coupling unit 25 can only be inserted into receiving unit 11 in one orientation. Bump 60 and recess 61 are of primarily corresponding, complementary form. In bump 60, an indentation 62 is provided at the height of screw 19 for turning screw 19. Corresponding to dump 60, screw 19 is provided with a groove 63, yet not extending around the entire circumference of screw 19. When screw 19 is turned in a manner that its groove 63 is arranged in the region of bump 60, the coupling unit can be easily removed, with clamping elements 18, 52 being slightly released, opposite to transverse direction Q, by being moved within grooves 15, 22. This is, however, not possible when screw 19 is arranged in such a manner that it engages into indentation 62.

As shown in the exploded view of FIG. 7, each of said clamping elements 18, 52 is provided with two pins 64, 65 or 66, 67 engaging with corresponding recesses in central element 53 so as to prevent clamping elements 18, 52 being turned during turning of screw 19. In order to enable a limit stop on either both sides or on one side for turning clamping elements 18, 52, one of pins 65, 67 may partially have a smaller diameter, respectively, into which safety screws 68, 69 to be screwed into central element 53 engage.

Accordingly, the third embodiment is an advantageous possibility to fasten a coupling unit 25 to a receiving unit 11.

In the first and third embodiment, an actuator can be used instead of a clamping screw in order to lock or pre-clamp the clamping plate. Such actuator can be operated by means of a control unit, particularly a central control unit.

In particular, the electromagnet or the switchable permanent magnet of the further embodiments can also be actuated by a control unit which is also primarily a central control unit.

A central control unit is designed to perform also the control of the movement of the robot and of the gripper.

1. An apparatus for detachably fastening a gripper to a robot, comprising
a receiving unit and a coupling unit between which at least one form-fit and/or force-fit connecting element is provided,
characterized in that
the receiving unit includes a limit stop provided with an undercut for receiving a first section of the coupling unit therein,
the receiving unit and the coupling unit include complementary form elements designed to be inserted one into the other, and in that
the receiving unit further includes a clamping element for retaining the coupling unit in the limit stop of the receiving unit.

2. The apparatus according to claim 1, wherein the complementary form elements are designed in such a manner that the coupling unit can be inserted into the receiving unit in just one orientation.

3. The apparatus according to claim 1, wherein the limit stop is formed as a groove with side faces tapering towards each other, and the first section of the coupling unit is of a complementary conical shape so that a seat with no play of the first section of the coupling unit in the limit stop of the receiving unit can be ensured.

4. The apparatus according to claim 1, wherein the clamping element and the limit stop are provided at two opposite sides of a base plate of the receiving unit, and the complementary form elements are provided between the clamping element and the limit stop.

5. The apparatus according to claim 1, wherein the clamping element includes a limit stop with an undercut designed to receive a second section of the coupling unit therein which is provided opposite to the first section of the coupling unit.

6. The apparatus according to claim 5, wherein the limit stop of the clamping element is a groove, recessed in its center region of extension, with conical side faces and wherein the second section of the coupling unit is also conically shaped.

7. The apparatus according to claim 1, wherein the clamping element includes a clamping plate in which the limit stop is formed, and a screw for locking and/or pre-clamping the clamping plate towards the coupling unit.

8. The apparatus according to claim 1, wherein the limit stop is formed by means of an indentation in one side wall at the receiving unit so as to form the undercut.

9. The apparatus according to claim 8, wherein the indentation of the limit stop is formed as a groove extending in the direction of extension of the side wall, said groove being of a shape recessed in its center region in the direction of extension so as to enable safe locking of the coupling unit in the direction of extension of the groove.

10. The apparatus according to claim 1, wherein the limit stop is formed in a counter clamping element designed to move into a direction opposing the movement of the clamping element in order to fasten the coupling unit between the clamping element and the counter clamping element.

11. The apparatus according to claim 10, wherein the screw passes through the receiving unit and includes regions with opposite pitches for the clamping element and for the counter clamping element, respectively, the clamping element and the counter clamping element being in engagement therewith, respectively.

12. The apparatus according to claim 10, wherein the limit stop of the counter clamping element and the limit stop of the clamping element are designed as straight grooves parallel towards each other and the screw, depending on the turning position, engages into an indentation in the coupling unit so as to lock the coupling unit with regard to the receiving unit in the direction of extension of the grooves.

13. The apparatus according to of claim 1, wherein the clamping element is designed to retain the coupling unit by means of a magnetic force.

14. The apparatus according to claim 13, wherein the receiving unit includes a locking pin engaging with the coupling unit to prevent that the first section of the coupling unit releases from the limit stop when the magnetic retaining force is switched off.

15. A method for detachably fastening a gripper to a robot, wherein a coupling unit and a receiving unit are provided, comprising the steps:
inserting a first section of the coupling unit into a limit stop of the receiving unit in undercut manner, while the receiving unit and the coupling unit are at an acute angle towards each other with regard to their normal operating position;
moving the second section of the coupling unit opposite to the first section until the receiving unit and the coupling unit are in normal operating position towards each other, wherein complementary form elements in the receiving unit and in the coupling unit engage with each another; and
applying a force by means of a clamping element to retain the coupling unit in abutment with the receiving unit.
